(19) United States
(12) Patent Application Publication
(10) Pub. No.: US 2021/0053041 A1
(43) Pub. Date: Feb. 25, 2021

(54) PROCESS FOR PREPARING A ZEOLITIC MATERIAL COMPRISING TI AND HAVING FRAMEWORK TYPE CHA

(71) Applicant: BASF SE, Ludwigshafen am Rhein (DE)

(72) Inventors: Mathias FEYEN, Ludwigshafen (DE); Ulrich MUELLER, Ludwigshafen (DE); Xinhe BAO, Dalian City (CN); Weiping ZHANG, Dalian City (CN); Dirk DE VOS, Leuven (BE); Hermann GIES, Bochum (DE); Feng-Shou XIAO, Hangzhou (CN); Toshiyuki YOKOI, Tokyo (JP); Ute KOLB, Mainz (DE); Bernd MARLER, Bochum (DE); Yong WANG, Tokyo (JP); Trees DE BAERDEMAEKER, Leuven (BE); Chuan SHI, Dalian (CN); Xiangju MENG, Hangzhou (CN); Xiulian PAN, Dalian City (CN)

(73) Assignee: BASF SE, Ludwigshafen am Rhein (DE)

(21) Appl. No.: 16/967,918

(22) PCT Filed: Jan. 23, 2019
(86) PCT No.: PCT/CN2019/072771

§ 371 Date: Aug. 6, 2020

(30) Foreign Application Priority Data
Feb. 7, 2018 (CN) PCT/CN2018/075559

(51) Int. Cl. B01J 29/89; C01B 37/00; B01J 37/00; B01J 37/04; B01J 37/10

(52) U.S. Cl. CPC B01J 29/89; C01B 37/005; B01J 37/0018; B01J 37/04; C01P 2002/72; C01P 2004/03; C01P 2002/82; C01P 2002/88; B01J 37/10

(57) ABSTRACT

A process for preparing a zeolitic material comprising Ti, having framework type CHA and having a framework structure which comprises Si and O, said process comprising (i) preparing a pre-synthesis mixture comprising water, a CHA framework structure directing agent, and a zeolitic material comprising Ti, having framework type MFI and having a framework structure which comprises Si and O; (ii) removing water from the pre-synthesis mixture obtained from (i) by heating the pre-synthesis mixture to a temperature of less than 100° C. at a pressure of less than 1 bar (abs); (iii) hydrothermally crystallizing the zeolitic material comprising Ti, having framework type CHA and having a framework structure which comprises Si and O.

The present invention relates to a process for preparing a zeolitic material comprising Ti, having framework type CHA and having a framework structure which comprises Si and O. Furthermore, the present invention relates to a zeolitic material comprising Ti, having framework type CHA and having a framework structure which comprises Si and O, which is obtainable or obtained by said process, and further relates to the use of said zeolitic material as a catalytically active material, as a catalyst, or as a catalyst component.

Zeolitic materials having framework type CHA are known to be potentially effective as catalysts or catalyst components for treating combustion exhaust gas in industrial applications, for example for converting nitrogen oxides (NOₓ) in an exhaust gas stream. Synthetic CHA zeolitic materials may be produced by precipitating crystals of the zeolitic material from a synthesis mixture which contains the sources of the elements from which the zeolitic framework is built, such as a source of silicon

An alternative approach may be the preparation via zeolitic framework conversion according to which a starting material which is a suitable zeolitic material comprising Si, having a framework type MFI is suitably reacted to obtain the zeolitic material having framework type CHA.

It was an object of the present invention to find suitable synthesis conditions which have to employed for preparing a zeolitic material comprising Ti having framework type CHA. Surprisingly, it was found that whether or not said zeolitic materials having framework type CHA may be formed depends on suitably adjusting said molar ratio of the pre-synthesis mixture prior to performing a hydrothermal crystallization step.

Therefore, the present invention relates to a process for preparing a zeolitic material comprising Ti, having framework type CHA and having a framework structure which comprises Si and O, said process comprising
(i) preparing a pre-synthesis mixture comprising water, a CHA framework structure directing agent, and a zeolitic material comprising Ti, having framework type MFI and having a framework structure which comprises Si and O, wherein the molar ratio of the CHA framework structure directing agent relative to Si, comprised in the zeolitic material having framework type MFI and calculated as SiO₂, said molar ratio being defined as SDA:SiO₂, is at least 0.4:1, and wherein the molar ratio of water relative to Si, comprised in the zeolitic material having framework type MFI and calculated as SiO₂, said molar ratio being defined as H₂O:SiO₂, is at least 30:1;
(ii) removing water from the pre-synthesis mixture obtained from (i) by heating the pre-synthesis mixture to a temperature of less than 100° C. at a pressure of less than 1 bar(abs) and keeping the temperature of the mixture in this range and the pressure of the mixture in this range, obtaining a synthesis mixture comprising water, the CHA framework structure directing agent, and the zeolitic material having framework type MFI, wherein the molar ratio of water relative to Si, comprised in the zeolitic material having framework type MFI and calculated as SiO₂, said molar ratio being defined as H₂O:SiO₂, is at most 25:1;
(iii) hydrothermally crystallizing the zeolitic material comprising Ti, having framework type CHA and having a framework structure which comprises Si and O, comprising heating the synthesis mixture obtained from (ii) to a temperature in the range of from 140 to 200° C. and keeping the temperature of the mixture in this range under autogenous pressure, obtaining a mother liquor comprising water and the zeolitic material comprising Ti, having framework type CHA and having a framework structure which comprises Si and O.

The CHA framework structure directing agent according to (i) can be any agent which results in the preparation of a zeolitic material comprising Ti having framework type CHA according to (iii). Preferably, the CHA framework structure directing agent comprises one or more of a N-alkyl-3-quinuclidinol, a N,N,N-trialkylexoaminonorbornane, a N,N,N-trimethyl-1-adamantylammonium compound, a N,N,N-trimethyl-2-adamantylammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzylammonium compound, more preferably a hydroxide thereof, wherein more preferably, the CHA framework structure directing agent comprise one or more of a N,N,N-trimethyl-1-adamantylammonium compound, more preferably comprises, more preferably is N,N,N-trimethyl-1-adamantylammonium hydroxide. If a N,N,N-trimethyl-1-adamantylammonium compound is employed in step (i), it can be employed in combination with at least one further suitable ammonium compound such as, e.g., a N,N,N-trimethylbenzylammonium (benzyltrimethylammonium) compound or a tetramethylammonium compound or a mixture of a benzyltrimethylammonium compound and a tetramethylammonium compound.

In addition to Si, Ti, O, and H, the zeolitic material comprising Ti having framework type MFI comprised in the pre-synthesis mixture (i) and synthesis mixture (ii) may comprise one or more further additional elements, for example one or more of Ge, Sn, V, Al, Ga, In and B. Preferably at least 99 weight-%, more preferably at least 99.5 weight-%, more preferably at least 99.9 weight-% of the zeolitic material having framework type MFI consist of Si, Ti, O, and H.

The zeolitic material having framework type MR comprised in the pre-synthesis mixture (i) and synthesis mixture (ii) exhibits a molar ratio of Si, calculated as SiO₂, to Ti, calculated as TiO₂, said molar ratio being defined as SiO₂:TiO₂, of preferably at least 10:1, more preferably in the range of from 10:1 to 50:1, more preferably in the range of from 15:1 to 45:1, more preferably in the range of from 20:1 to 40:1, more preferably in the range of from 30:1 to 35:1. Preferably, the zeolitic, material having framework type MR exhibits a molar ratio of Si, calculated as SiO₂, to Ti, calculated as TiO₂, said molar ratio being defined as SiO₂:TiO₂, in the range of from 31:1 to 34:1, more preferably in the range of from 32:1 to 33:1. Preferably, the zeolitic material having framework type MR is a titanium silicalite-1, preferably the TS-1 according to reference example 2. The zeolitic material having framework type MR is preferably a calcined material, more preferably a material calcined in a gas atmosphere having a temperature in the range of from 500 to 800° C., wherein said gas atmosphere preferably comprises oxygen, more preferably is one or more of oxygen, air, or lean air.

Preferably, in the pre-synthesis mixture prepared in (i) and subjected to (ii), the molar ratio SDA:SiO₂ is in the range of from 0.4:1 to 2:1, more preferably in the range of from 0.5:1 to 1.5:1, more preferably in the range of from 0.6:1 to 1.0:1.

Preferably, in the pre-synthesis mixture prepared in (i) and subjected to (ii), the molar ratio H₂O:SiO₂, is in the range of from 30:1 to 50:1, more preferably in the range of from 30:1 to 45:1, more preferably in the range of from 30:1 to 40:1.

Preferably, the pre-synthesis mixture prepared in (i) and subjected to (ii) further comprises a source of an alkali metal M, preferably one or more of Na, K, Cs, more preferably one or more of Na and K, more preferably Na, wherein the source of the alkali metal M preferably comprises, more preferably is MOH. Preferably, in the pre-synthesis mixture prepared in (i) and subjected to (ii), the molar ratio of the source of M, calculated as elemental M, relative to Si, comprised in the zeolitic material having framework type MFI and calculated as SiO₂, said molar ratio being defined as M:SiO₂, is in the range of from 0.005:1 to 0.1:1, more preferably in the range of from 0.075:1 to 0.09:1, more preferably in the range of from 0.01:1 to: 0.08:1. Preferably, the pre-synthesis mixture prepared in (i) and subjected to (ii) does not comprises a source of an alkali metal M.

In the context of the present invention it is conceivable that a seed material is employed. Preferably, the pre-synthesis mixture prepared in (i) and subjected to (ii) further comprises a crystalline seed material comprising, preferably consisting of a zeolitic material comprising Ti, having framework type CHA and having a framework structure which comprises Si and O.

Preferably, in the pre-synthesis mixture prepared in (i) and subjected to (ii), the molar ratio of Si, comprised in the zeolitic material having framework type CHA comprised in the seed material and calculated as elemental Si, relative to Si, comprised in the zeolitic material having framework type MFI and calculated as SiO₂, said molar ratio being defined as Si:SiO₂, is in the range of from 0.001:1 to 0.02:1, more preferably in the range of from 0.005:1 to 0.015:1, more preferably in the range of from 0.0075:1 to 0.0125:1.

Preferably, at least 95 weight-%, more preferably at least 98 weight-%, more preferably at least 99 weight-%, more preferably at least 99.5 weight-% of the pre-synthesis mixture prepared in (i) and subjected to (ii) consist of water, the CHA framework structure directing agent, the zeolitic material comprising Ti, having framework type MFI and having a framework structure comprising Si and O, preferably the source of Na as defined herein above, and preferably the seed material as defined herein above.

In the context of the present invention advantageously low amounts of aluminum may be employed. Preferably, the aluminum content of the pre-synthesis mixture prepared in (i) and subjected to (ii), calculated as elemental Al, is at most 500 weight-ppm, more preferably at most 250 weight-ppm, more preferably at most 100 weight-ppm, based on the total weight of the pre-synthesis mixture.

Preferably, the fluorine content of the pre-synthesis mixture prepared in (i) and subjected to (ii), calculated as elemental F, is at most 500 weight-ppm, more preferably at most 250 weight-ppm, more preferably at most 100 weight-ppm, based on the total weight of the pre-synthesis mixture.

The pre-synthesis mixture prepared in (i) and subjected to (ii) preferably has a temperature in the range of from 10 to 40° C. Preferably, preparing the pre-synthesis mixture according to (i) comprises agitating, more preferably mechanically agitating, more preferably stirring the pre-synthesis mixture, wherein said agitating is preferably carried out for a time of at least 1 min, more preferably for a time in the range of from 1 to 60 min, more preferably for a time in the range of from 5 to 30 min.

As to step (ii), it is preferred that according to (ii), the pre-synthesis mixture is heated to a temperature of less than 100° C. at a pressure in the range of from 5 to 750 mbar(abs), more preferably in the range of from 10 to 500 mbar(abs), more preferably in the range of from 15 to 250 mbar(abs), more preferably in the range of from 20 to 200 mbar(abs), more preferably in the range of from 25 to 150 mbar(abs), more preferably in the range of from 30 to 100 mbar(abs), more preferably in the range of from 35 to 75 mbar(abs), more preferably in the range of from 40 to 60 mbar(abs). Preferably, according to (ii), the pre-synthesis mixture is heated to a temperature in the range of from 40 to 90° C., more preferably in the range of from 45 to 80° C., more preferably in the range of from 50 to 70° C., more preferably in the range of from 60 to 70° C. Preferably, according to (ii), the pre-synthesis mixture is heated to a temperature of less than 100° C. and kept at said temperature for a time in the range of from 1 to 6 h, more preferably in the range of from 2 to 5 h, more preferably in the range of from 3 to 4 h. Preferably, in the synthesis mixture obtained from (ii), the molar ratio of water relative to relative to Si, comprised in the zeolitic material having framework type MFI and calculated as SiO₂, said molar ratio being defined as H₂O:SiO₂, is in the range of from 5:1 to 25:1, more preferably in the range of from 7.5:1 to 20:1, more preferably in the range of from 10:1 to 17.5:1.

As to step (iii), it is preferred that hydrothermally crystallizing according to (iii) comprises heating the synthesis mixture obtained from (ii) to a temperature in the range of from 145 to 190° C., more preferably in the range of from 150 to 180° C., more preferably in the range of from 155 to 170° C., more preferably in the range of from 155 to 165° C., more preferably in the range of from 160 to 165° C. Preferably, hydrothermally crystallizing according to (iii) comprises keeping the temperature of the mixture in this range under autogenous pressure for 1 to 20 d, more preferably in the range of from 3 to 15 d, more preferably from 5 to 10 d, more preferably in the range of from 6 to 9 d. Preferably, hydrothermally crystallizing according to (iii) is carried out in an autoclave. Heating according to (iii) is preferably carried out at a heating rate in the range of from 0.5 to 4 K/min, more preferably in the range of from 1 to 3 k/min. Hydrothermally crystallizing according to (iii) is preferably carried out under static conditions. Hydrothermally crystallizing according to (iii) preferably comprises agitating, more preferably mechanically agitating, more preferably stirring the synthesis mixture.

Depending on the intended use of the zeolitic material of the present invention, preferably obtained from (iii) of the inventive process can be employed as such. Further, it is conceivable that the zeolitic material is subjected to one or more further post-treatment steps. For example, the zeolitic material which is most preferably obtained as a powder can be suitably processed to a moulding or a shaped body by any suitable method, including, but no restricted to, extruding, tabletting, spraying and the like. Preferably, the shaped body may have a rectangular, a triangular, a hexagonal, a square, an oval or a circular cross section, and/or preferably is in the form of a star, a tablet, a sphere, a cylinder, a strand, or a hollow cylinder. When preparing a shaped body, one or more binders can be used which may be chosen according to the intended use of the shaped body. Possible binder materials include, but are not restricted to, graphite, silica, titania, zirconia, alumina, and a mixed oxide of two or more of silicon, titanium and zirconium. The weight ratio of the zeolitic material relative to the binder is generally not subject to any specific restrictions and may be, for example, in the range of from 10:1 to 1:10. According to a further example according to which the zeolitic material is used, for example, as a catalyst or as a catalyst component for treating an exhaust gas stream, for example an exhaust gas stream of an engine, it is possible that the zeolitic material is used as a component of a washcoat to be applied onto a suitable substrate, such as a wall-flow filter or the like.

From the hydrothermal crystallizing step according to (iii), a mother liquor is obtained comprising water and the zeolitic material comprising Ti, having framework type CHA and having a framework structure which comprises Si and O, at the hydrothermal crystallization temperature. Since the hydrothermal crystallizing step according to (iii) is carried out under autogenous pressure, it is preferred (iii) further comprises depressurizing the mixture. Either before, during, or after depressurizing, the inventive process preferably further comprises:
(iv) cooling the mother liquor obtained from (iii).

While there are no specific restrictions, it is preferred to cool the mixture to a temperature in the range of from 10 to 50° C., more preferably in the range of from 20 to 35° C.

Since, as mentioned above, according to (iii) a mother liquor is obtained comprising water and the zeolitic material comprising Ti, having framework type CHA, it is further preferred that the inventive process further comprises:
(v) separating the zeolitic material from the mother liquor obtained from (iii) or (iv).

There are no specific restrictions on how the zeolitic material is separated. Preferably, separating according to (v) comprises
(v.1) subjecting the mother liquor obtained from (iii) or (iv), preferably from (iv), to a solid-liquid separation method;
(v.2) preferably washing the zeolitic material obtained from (v.1);
(v.3) preferably drying the zeolitic material obtained from (v.1) or (v.2), preferably from (v.2).

As to (v.1), it is preferred that the solid-liquid separation method, preferably comprising centrifugation, filtration, or rapid-drying, more preferably spray-drying, more preferably comprising centrifugation. If (v.2) is carried out, it is preferred that the zeolitic material is washed with water, more preferably distilled water, preferably until the washing water has a conductivity of at most 500 microSiemens, more preferably at most 200 microSiemens. If (v.3) is carried out, it is preferred that the zeolitic material is dried in a gas atmosphere having a temperature in the range of from 10 to 50° C., more preferably in the range of 25 to 30° C. Preferably, the gas atmosphere comprises oxygen, preferably is air, lean air, or synthetic air.

Preferably, the inventive process further comprises
(vi) calcining the zeolitic material obtained from (v).

If step (vi) is carried out, the zeolitic material is preferably calcined in a gas atmosphere having a temperature in the range of from 300 to 700° C., more preferably in the range of from 350 to 600° C., more preferably in the range of from 400 to 600° C., more preferably in the range of from 450 to 550° C. Preferably, the gas atmosphere comprises oxygen, more preferably is air, lean air, or synthetic air.

Preferably, the inventive process further comprises
(vii) subjecting the zeolitic material obtained from (v) or (vi), more preferably from (vi), to ion exchange conditions, comprising bringing a solution comprising ammonium ions in contact with the zeolitic material obtained from (v) or (vi), preferably from (vi), obtaining a zeolitic material having framework type CHA in its ammonium form.

If step (vii) is carried out, the solution comprising ammonium ions according to (vii) is preferably an aqueous solution comprising a dissolved ammonium salt, more preferably a dissolved inorganic ammonium salt, more preferably dissolved ammonium nitrate. Preferably, the solution comprising ammonium ions according to (vii) has an ammonium concentration in the range of from 1 to 5 mol/l, more preferably in the range of from 1.5 to 4 more preferably in the range of from 2 to 3 mol/l. Preferably, according to (vii), the solution comprising ammonium ions is brought in contact with the zeolitic material obtained from (v) or (vi), more preferably from (vi), at a temperature of the solution in the range of from 50 to 95° C., preferably in the range of from 60 to 90° C., more preferably in the range of from 70 to 85° C. Preferably, the solution comprising ammonium ions is brought in contact with the zeolitic material obtained from (v) or (vi), more preferably from (vi), for a period of time in the range of from 1 to 5 hours, preferably from 2 to 4 hours, more preferably in the range of from 2.5 to 3.5 h. Preferably, bringing the solution in contact with the zeolitic material according to (vii) is repeated at least once, more preferably once or twice, more preferably once. Preferably, bringing the solution in contact with the zeolitic material according to (vii) comprises one or more of impregnating the zeolitic material with the solution and spraying the solution onto the zeolitic material, preferably impregnating the zeolitic material with the solution.

If step (vii) is carried out, the inventive process preferably further comprises
(viii) calcining the zeolitic material obtained from (vii), obtaining the H-form of the zeolitic material.

If step (viii) is carried out, the zeolitic material is preferably calcined in a gas atmosphere having a temperature in the range of from 300 to 700° C., more preferably in the range of from 350 to 600° C., more preferably in the range of from 400 to 600° C., more preferably in the range of from 450 to 550° C. Preferably, the gas atmosphere comprises oxygen, preferably is air, lean air, or synthetic air.

If step (v) is carried out, preferably steps (v) and (vi), more preferably steps (v), (vi), (vii) and (viii), more preferably steps (v), (vi) and (vii) are carried out, preferably, the inventive process further comprises
(ix) subjecting the zeolitic material obtained from (vi) or (vii) or (viii), preferably from (vii) or (viii), more preferably from (vii), to ion exchange conditions, comprising bringing the zeolitic, material in contact with a solution comprising ions of a transition metal of groups 7 to 12 of the periodic table, obtaining a mixture comprising the zeolitic material comprising a transition metal, wherein the transition metal is preferably one or more of Cu and Fe.

If step (ix) is carried out, the solution comprising ions of a transition metal according to (ix) is preferably an aqueous solution comprising a dissolved salt of the transition metal M, more preferably a dissolved inorganic salt of the transition metal M, more preferably a dissolved nitrate of the transition metal M. The solution comprising ions of a transition metal according to (ix) preferably has a concentration of the transition metal in the range of from 0.0005 to 1 mol/l, more preferably in the range of from 0.001 to 0.5 mol/l, more preferably in the range of from 0.002 to 0.2 mol/l. Preferably, according to (ix), the solution comprising ions of a transition metal M is brought in contact with the zeolitic material at a temperature of the solution in the range of from 10 to 40° C., more preferably in the range of from 15 to 35° C., more preferably in the range of from 20 to 30° C. Preferably, the solution comprising ions of a transition metal is brought in contact with the zeolitic material for a period of time in the range of from 6 to 48 h, more preferably from 12 to 36 h, more preferably in the range of from 18 to 30 h. Preferably, bringing the solution in contact with the zeolitic material according to (ix) is repeated at least once. Bringing the solution in contact with the zeolitic material according to (ix) preferably comprises one or more of impregnating the zeolitic material with the solution and spraying the solution onto the zeolitic material, more preferably impregnating the zeolitic, material with the solution.

If step (ix) is carried out, the inventive process further preferably comprises
(x) separating the zeolitic material from the mixture obtained from (ix).

If step (x) is carried out, separating the zeolitic material according to (x) preferably comprises
(x.1) subjecting the mixture obtained from (ix) to a solid-liquid separation method, obtaining the zeolitic material comprising a transition metal M;
(x.2) preferably washing the zeolitic material obtained from (x.1);
(x.3) drying the zeolitic material obtained from (x.1) or (x.2), preferably from (x.2).

As to (x.1), it is preferred that the solid-liquid separation method comprises a filtration method or a centrifugation method or a spraying method. If (x.2) is carried out, it is preferred that the zeolitic material is washed with water, preferably until the washing water has a conductivity of at most 500 microSiemens, more preferably at most 200 microSiemens. As to (x.3), it is preferred that the zeolitic material is dried in a gas atmosphere having a temperature in the range of from 50 to 150° C., more preferably in the range of from 75 to 125° C., more preferably in the range of from 90 to 110° C. Preferably, the gas atmosphere comprises oxygen, more preferably is air, lean air, or synthetic air.

If step (x) is carried out, the inventive process preferably further comprises
(xi) calcining the zeolitic material obtained from (x).

If step (xi) is carried out, the zeolitic material is preferably calcined in a gas atmosphere having a temperature in the range of from 400 to 600° C., more preferably in the range of from 450 to 550° C., more preferably in the range of from 475 to 525° C. Preferably, the gas atmosphere comprises oxygen, more preferably is one or more of oxygen, air, or lean air.

Depending on the intended use of the zeolitic material of the present invention, preferably obtained from (ix), (x) or (xi) of the inventive process can be employed as such. Further, it is conceivable that the zeolitic material is subjected to one or more further post-treatment steps. For example, the zeolitic material which is most preferably obtained as a powder can be suitably processed to a moulding or a shaped body by any suitable method, including, but no restricted to, extruding, tabletting, spraying and the like. Preferably, the shaped body may have a rectangular, a triangular, a hexagonal, a square, an oval or a circular cross section, and/or preferably is in the form of a star, a tablet, a sphere, a cylinder, a strand, or a hollow cylinder. When preparing a shaped body, one or more binders can be used which may be chosen according to the intended use of the shaped body. Possible binder materials include, but are not restricted to, graphite, silica, Mania, zirconia, alumina, and a mixed oxide of two or more of silicon, titanium and zirconium. The weight ratio of the zeolitic material relative to the binder is generally not subject to any specific restrictions and may be, for example, in the range of from 10:1 to 1:10. According to a further example according to which the zeolitic material is used, for example, as a catalyst or as a catalyst component for treating an exhaust gas stream, for example an exhaust gas stream of an engine, it is possible that the zeolitic material is used as a component of a washcoat to be applied onto a suitable substrate, such as a wall-flow filter or the like.

The present invention further relates to a zeolitic material comprising Ti, having framework type CNA and having a framework structure which comprises Si and O, obtainable or obtained by a process described herein above.

Preferably, said zeolitic material is in the sodium form, preferably obtainable or obtained by a process as described herein above, wherein said process preferably further comprises step (iv), more preferably further comprises steps (iv) and (v), more preferably further comprises steps (iv), (v) and (vi).

Preferably, said zeolitic material is in the ammonium form, preferably obtainable or obtained by a process as described herein above, wherein said process preferably further comprises step (vii).

Preferably, said zeolitic material is in the H form, preferably obtainable or obtained by a process as described herein above, wherein said process preferably further comprises step (viii).

Preferably, said zeolitic material is in the Cu/Fe form, preferably obtainable or obtained by a process as described herein above, wherein said process preferably further comprises step (ix), more preferably further comprises steps (ix) and (x), more preferably further comprises steps (ix), (x) and (xi).

The zeolitic material of the present invention comprising Ti, having framework type CNA and having a framework structure which comprises Si and O can be used for any conceivable purpose, including, but not limited to, an absorbent, a molecular sieve, a catalyst, a catalyst carrier or an intermediate for preparing one or more thereof. Preferably, the zeolitic material of the present invention is used as a catalytically active material, as a catalyst, or as a catalyst component, more preferably, for the selective catalytic reduction of nitrogen oxides in an exhaust gas stream, more preferably an exhaust gas stream from a diesel engine. More preferably, for the conversion of a C1 compound to one or more olefins, more preferably for the conversion of methanol to one or more olefins or the conversion of a synthetic gas comprising carbon monoxide and hydrogen to one or more olefins, more preferably for the conversion of methanol to one or more olefins or the conversion of a synthetic gas comprising carbon monoxide and hydrogen to one or more olefins. More preferably, for the oxidation of an alkene, preferably for the epoxidation of an alkene, wherein the alkene is preferably one or more of ethene and propene, more preferably is ethene.

Further, the present invention relates to a method for selectively catalytically reducing nitrogen oxides in an exhaust gas stream, preferably an exhaust gas stream from a diesel engine, said method comprising bringing said exhaust gas stream in contact with a catalyst comprising the zeolitic material according to the present invention.

Yet further, the present invention relates to a method for selectively catalytically reducing nitrogen oxides in an exhaust gas stream, preferably an exhaust gas stream from a diesel engine, said method comprising preparing a zeolitic material by a process according to the present invention, preferably a process according to the present invention which comprises step (ix), and bringing said exhaust gas stream in contact with a catalyst comprising said zeolitic material.

The present invention also relates to a method for catalytically converting a C1 compound to one or more olefins, preferably converting methanol to one or more olefins or converting a synthetic gas comprising carbon monoxide and hydrogen to one or more olefins, said method comprising bringing said C1 compound in contact with a catalyst comprising the zeolitic material according to the present invention.

The present invention further relates to a method for catalytically converting a C1 compound to one or more olefins, preferably converting methanol to one or more olefins or converting a synthetic gas comprising carbon monoxide and hydrogen to one or more olefins, said method comprising preparing a zeolitic material by a process according to the present invention, and bringing said C1 compound in contact with a catalyst comprising said zeolitic material.

Further, the present invention relates to a method for oxidation of an alkene, preferably for the epoxidation of an alkene, wherein the alkene is preferably one or more of ethene and propene, more preferably is ethene, said method comprising bringing said alkene in contact with a catalyst comprising the zeolitic material according to the present invention.

Yet further, the present invention relates to a method for oxidation of an alkene, preferably for the epoxidation of an alkene, wherein the alkene is preferably one or more of ethene and propene, more preferably is ethene, said method comprising preparing a zeolitic material by a process according to the present invention, and bringing said alkene in contact with a catalyst comprising said zeolitic material.

Further, the present invention relates to a catalyst, preferably a catalyst for selectively catalytically reducing nitrogen oxides in an exhaust gas stream, preferably an exhaust gas stream from a diesel engine, or for catalytically converting a C1 compound to one or more olefins, preferably converting methanol to one or more olefins, or for converting a synthetic gas comprising carbon monoxide and hydrogen to one or more olefins, or for the epoxidation of an alkene, said catalyst comprising the zeolitic material according to the present invention, preferably the zeolitic material according to the present invention comprising a transition metal of groups 7 to 12 of the periodic table.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. A process for preparing a zeolitic material comprising Ti, having framework type CHA and having a framework structure which comprises Si and O, said process comprising
   (i) preparing a pre-synthesis mixture comprising water, a CHA framework structure directing agent, and a zeolitic material comprising Ti, having framework type MFI and having a framework structure which comprises Si and O, wherein the molar ratio of the CHA framework structure directing agent relative to Si, comprised in the zeolitic material having framework type MFI and calculated as SiO₂, said molar ratio being defined as SDA:SiO₂, is at least 0.4:1, and wherein the molar ratio of water relative to Si, comprised in the zeolitic material having framework type MR and calculated as SiO₂, said molar ratio being defined as H₂O:SiO₂, is at least 30:1;
   (ii) removing water from the pre-synthesis mixture obtained from (i) by heating the pre-synthesis mixture to a temperature of less than 100° C. at a pressure of less than 1 bar(abs) and keeping the temperature of the mixture in this range and the pressure of the mixture in this range, obtaining a synthesis mixture comprising water, the CHA framework structure directing agent, and the zeolitic material having framework type MFI, wherein the molar ratio of water relative to Si, comprised in the zeolitic, material having framework type MR and calculated as SiO₂, said molar ratio being defined as H₂O:SiO₂, is at most 25:1;
   (iii) hydrothermally crystallizing the zeolitic material comprising Ti, having framework type CHA and having a framework structure which comprises Si and O, comprising heating the synthesis mixture obtained from (ii) to a temperature in the range of from 140 to 200° C. and keeping the temperature of the mixture in this range under autogenous pressure, obtaining a mother liquor comprising water and the zeolitic material comprising Ti, having framework type CHA and having a framework structure which comprises Si and O.
2. The process of embodiment 1, wherein the CHA framework structure directing agent comprises one or more of a N-alkyl-3-quinuclidinol, a N,N,N-trialkylexoaminonorbornane, a N,N,N-trimethyl-1-adamantylammonium compound, a N,N,N-trimethyl-2-adamantylammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzylammonium compound, preferably a hydroxide thereof, wherein more preferably, the CHA framework structure directing agent comprise one or more of a N,N,N-trimethyl-1-adamantylammonium compound, more preferably comprises, more preferably is N,N,N-trimethyl-1-adamantylammonium hydroxide.
3. The process of embodiment 1 or 2, wherein at least 99 weight-%, preferably at least 99.5 weight-%, more preferably at least 99.9 weight-% of the zeolitic material having framework type MR consist of Si, Ti, O, and H.
4. The process of any one of embodiments 1 to 3, wherein zeolitic material having framework type MFI exhibits a molar ratio of Si, calculated as SiO₂, to Ti, calculated as TiO₂, said molar ratio being defined as SiO₂:TiO₂, of at least 10:1, preferably in the range of from 10:1 to 50:1, more preferably in the range of from 15:1 to 45:1, more preferably in the range of from 20:1 to 40:1, more preferably in the range of from 30:1 to 35:1.
5. The process of any one of embodiments 1 to 4, wherein the zeolitic material having framework type MFI exhibits a molar ratio of Si, calculated as SiO₂, to Ti, calculated as TiO₂, said molar ratio being defined as SiO₂:TiO₂, in the range of from 31:1 to 34:1, preferably in the range of from 32:1 to 33:1.
6. The process of any one of embodiments 1 to 5, wherein the zeolitic material having framework type MFI is a titanium silicalite-1, preferably the TS-1 according to reference example 2.
7. The process of any one of embodiments 1 to 6, wherein the zeolitic material having framework type MFI is a calcined material, preferably a material calcined in a gas atmosphere having a temperature in the range of from 500 to 800° C., wherein said gas atmosphere preferably comprises oxygen, more preferably is one or more of oxygen, air, or lean air.
8. The process of any one of embodiments 1 to 7, wherein in the pre-synthesis mixture prepared in (i) and subjected to (ii), the molar ratio SDA:SiO₂ is in the range of from 0.4:1 to 2:1, preferably in the range of from 0.5:1 to 1.5:1, more preferably in the range of from 0.6:1 to 1.0:1.
9. The process of any one of embodiments 1 to 8, wherein in the pre-synthesis mixture prepared in (i) and subjected to (ii), the molar ratio H₂O:SiO₂, is in the range of from 30:1 to 50:1, preferably in the range of from 30:1 to 45:1, more preferably in the range of from 30:1 to 40:1.
10. The process of any one of embodiments 1 to 9, wherein the pre-synthesis mixture prepared in (i) and subjected to (ii) further comprises a source of an alkali metal M, preferably one or more of Na, K, Cs, more preferably one or more of Na and K, more preferably Na, wherein the source of the alkali metal M preferably comprises, more preferably is MOH.
11. The process of embodiment 10, wherein in the pre-synthesis mixture prepared in (i) and subjected to (ii), the molar ratio of the source of M, calculated as elemental M, relative to Si, comprised in the zeolitic material having framework type MFI and calculated as SiO₂, said molar ratio being defined as M:SiO₂, is in the range of from 0.005:1 to 0.1:1, preferably in the range of from 0.075:1 to 0.09:1, more preferably in the range of from 0.01:1 to: 0.08:1.
12. The process of any one of embodiments 1 to 11, wherein the pre-synthesis mixture prepared in (i) and subjected to (ii) does not comprises a source of an alkali metal M.
13. The process of any one of embodiments 1 to 12, wherein the pre-synthesis mixture prepared in (i) and subjected to (ii) further comprises a crystalline seed material comprising, preferably consisting of a zeolitic material comprising Ti, having framework type CHA and having a framework structure which comprises Si and O.
15. The process of embodiment 13 or 14, wherein in the pre-synthesis mixture prepared in (i) and subjected to (ii), the molar ratio of Si, comprised in the zeolitic material having framework type CHA comprised in the seed material and calculated as elemental Si, relative to Si, comprised in the zeolitic material having framework type MFI and calculated as SiO₂, said molar ratio being defined as Si:SiO₂, is in the range of from 0.001:1 to 0.02:1, preferably in the range of from 0.005:1 to 0.015:1, more preferably in the range of from 0.0075:1 to 0.0125:1.
16. The process of any one of embodiments 1 to 15, wherein at least 95 weight-%, preferably at least 98 weight-%, more preferably at least 99 weight-%, more preferably at least 99.5 weight-% of the pre-synthesis mixture prepared in (i) and subjected to (ii) consist of water, the CHA framework structure directing agent, the zeolitic material comprising Ti, having framework type MFI and having a framework structure comprising Si and O, preferably the source of Na as defined in any one of embodiments 10 to 12, and preferably the seed material as defined in any one of embodiments 13 to 15.
17. The process of any one of embodiments 1 to 16, wherein the aluminum content of the pre-synthesis mixture prepared in (i) and subjected to (ii), calculated as elemental Al, is at most 500 weight-ppm, preferably at most 250 weight-ppm, more preferably at most 100 weight-ppm, based on the total weight of the pre-synthesis mixture.
18. The process of any one of embodiments 1 to 17, wherein the fluorine content of the pre-synthesis mixture prepared in (i) and subjected to (ii), calculated as elemental F, is at most 500 weight-ppm, preferably at most 250 weight-ppm, more preferably at most 100 weight-ppm, based on the total weight of the pre-synthesis mixture.
19. The process of any one of embodiments 1 to 18, wherein the pre-synthesis mixture prepared in (i) and subjected to (ii) has a temperature in the range of from 10 to 40° C.
20. The process of any one of embodiments 1 to 19, wherein preparing the pre-synthesis mixture according to (i) comprises agitating, preferably mechanically agitating, more preferably stirring the pre-synthesis mixture, wherein said agitating is preferably carried out for a time of at least 1 min, more preferably for a time in the range of from 1 to 60 min, more preferably for a time in the range of from 5 to 30 min.
21. The process of any one of embodiments 1 to 20, wherein according to (ii), the pre-synthesis mixture is heated to a temperature of less than 100° C. at a pressure in the range of from 5 to 750 mbar(abs), preferably in the range of from 10 to 500 mbar(abs), more preferably in the range of from 15 to 250 mbar(abs), more preferably in the range of from 20 to 200 mbar(abs), more preferably in the range of from 25 to 150 mbar(abs), more preferably in the range of from 30 to 100 mbar(abs), more preferably in the range of from 35 to 75 mbar(abs), more preferably in the range of from 40 to 60 mbar(abs).
22. The process of any one of embodiments 1 to 21, wherein according to (ii), the pre-synthesis mixture is heated to a temperature in the range of from 40 to 90° C., preferably in the range of from 45 to 80° C., more preferably in the range of from 50 to 70° C., more preferably in the range of from 60 to 70° C.
23. The process of any one of embodiments 1 to 22, wherein according to (ii), the pre-synthesis mixture is heated to a temperature of less than 100° C. and kept at said temperature for a time in the range of from 1 to 6 h, preferably in the range of from 2 to 5 h, more preferably in the range of from 3 to 4 h.
24. The process of any one of embodiments 1 to 23, wherein in the synthesis mixture obtained from (ii), the molar ratio of water relative to relative to Si, comprised in the zeolitic material having framework type MFI and calculated as SiO₂, said molar ratio being defined as H₂O:SiO₂, is in the range of from 5:1 to 25:1, preferably in the range of from 7.5:1 to 20:1, more preferably in the range of from 10:1 to 17.5:1.
25. The process of any one of embodiments 1 to 24, wherein hydrothermally crystallizing according to (iii) comprises heating the synthesis mixture obtained from (ii) to a temperature in the range of from 145 to 190° C. preferably in the range of from 150 to 180° C., more preferably in the range of from 155 to 170° C., more preferably in the range of from 155 to 165° C., more preferably in the range of from 160 to 165° C.
26. The process of any one of embodiments 1 to 25, wherein hydrothermally crystallizing according to (iii) comprises keeping the temperature of the mixture in this range under autogenous pressure for 1 to 20 d, preferably in the range of from 3 to 15 d, more preferably from 5 to 10 d, more preferably in the range of from 6 to 9 d.
27. The process of any one of embodiments 1 to 26, wherein hydrothermally crystallizing according to (iii) is carried out in an autoclave.
28. The process according to any one of embodiments 1 to 27, wherein heating according to (iii) is carried out at a heating rate in the range of from 0.5 to 4 K/min, preferably in the range of from 1 to 3 K/min.
29. The process of any one of embodiments 1 to 28, wherein hydrothermally crystallizing according to (iii) is carried out under static conditions.
30. The process of any one of embodiments 1 to 28, wherein hydrothermally crystallizing according to (iii) comprises agitating, preferably mechanically agitating, more preferably stirring the synthesis mixture.
31. The process of any one of embodiments 1 to 30, further comprising
   (iv) cooling the mother liquor obtained from (iii), preferably to a temperature in the range of from 10 to 50° C., more preferably in the range of from 20 to 35° C.
32. The process of any one of embodiments 1 to 31, further comprising
   (v) separating the zeolitic material from the mother liquor obtained from (iii) or (iv).
33. The process of embodiment 32, wherein the separating according to (v) comprises
   (v.1) subjecting the mother liquor obtained from (iii) or (iv), preferably from (iv), to a solid-liquid separation method, preferably comprising centrifugation, filtration, or rapid-drying, preferably spray-drying, more preferably comprising centrifugation;
   (v.2) preferably washing the zeolitic material obtained from (v.1);
   (v.3) preferably drying the zeolitic material obtained from (v.1) or (v.2), preferably from (v.2).
34. The process of embodiment 33, wherein according to (v.2), the zeolitic material is washed with water, preferably distilled water, preferably until the washing water has a conductivity of at most 500 microSiemens, more preferably at most 200 microSiemens.
35. The process of embodiment 33 or 34, wherein according to (v.3), the zeolitic material is dried in a gas atmosphere having a temperature in the range of from 10 to 50° C., preferably in the range of 25 to 30° C.
36. The process of embodiment 35, wherein the gas atmosphere comprises oxygen, preferably is air, lean air, or synthetic air.
37. The process of any one of embodiments 32 to 36, further comprising
   (vi) calcining the zeolitic material obtained from (v).
38. The process of embodiment 37, wherein according to (vi), the zeolitic material is calcined in a gas atmosphere having a temperature in the range of from 300 to 700° C., preferably in the range of from 350 to 600° C., more preferably in the range of from 400 to 600° C., more preferably in the range of from 450 to 550° C.
39. The process of embodiment 38, wherein the gas atmosphere comprises oxygen, preferably is air, lean air, or synthetic air.
40. The process of any one of embodiments 32 to 39, preferably of any one of embodiments 37 to 39, further comprising
   (vii) subjecting the zeolitic material obtained from (v) or (vi), preferably from (vi), to ion exchange conditions, comprising bringing a solution comprising ammonium ions in contact with the zeolitic material obtained from (v) or (vi), preferably from (vi), obtaining a zeolitic material having framework type CHA in its ammonium form.
41. The process of embodiment 40, wherein the solution comprising ammonium ions according to (vii) is an aqueous solution comprising a dissolved ammonium salt, preferably a dissolved inorganic ammonium salt, more preferably dissolved ammonium nitrate.
42. The process of embodiment 40 or 41, wherein the solution comprising ammonium ions according to (vii) has an ammonium concentration in the range of from 1 to 5 mal/l, preferably in the range of from 1.5 to 4 mol/l, more preferably in the range of from 2 to 3 mol/l.
43. The process of any one of embodiments 40 to 42, wherein according to (vii), the solution comprising ammonium ions is brought in contact with the zeolitic material obtained from (v) or (vi), preferably from (vi), at a temperature of the solution in the range of from 50 to 95° C., preferably in the range of from 60 to 90° C., more preferably in the range of from 70 to 85° C.
44. The process of embodiment 43, wherein the solution comprising ammonium ions is brought in contact with the zeolitic material obtained from (v) or (vi), preferably from (vi), for a period of time in the range of from 1 to 5 hours, preferably from 2 to 4 hours, more preferably in the range of from 2.5 to 3.5 h.
45. The process of any one of embodiments 40 to 44, wherein bringing the solution in contact with the zeolitic material according to (vii) is repeated at least once, preferably once or twice, more preferably once.
46. The process of any one of embodiments 40 to 45, wherein bringing the solution in contact with the zeolitic material according to (vii) comprises one or more of impregnating the zeolitic material with the solution and spraying the solution onto the zeolitic material, preferably impregnating the zeolitic material with the solution.
47. The process of any one of embodiments 40 to 46, further comprising
   (viii) calcining the zeolitic material obtained from (vii), obtaining the H-form of the zeolitic material.
48. The process of embodiment 47, wherein according to (viii), the zeolitic material is calcined in a gas atmosphere having a temperature in the range of from 300 to 700° C., preferably in the range of from 350 to 600° C., more preferably in the range of from 400 to 600° C., more preferably in the range of from 450 to 550° C.
49. The process of embodiment 48, wherein the gas atmosphere comprises oxygen, preferably is air, lean air, or synthetic air.
50. The process of any one of embodiments 32 to 49, preferably of any one of embodiments 40 to 49, more preferably of any one of embodiments 40 to 46, further comprising
   (ix) subjecting the zeolitic material obtained from (vi) or (vii) or (viii), preferably from (vii) or (viii), more preferably from (vii), to ion exchange conditions, comprising bringing the zeolitic material in contact with a solution comprising ions of a transition metal of groups 7 to 12 of the periodic table, obtaining a mixture comprising the zeolitic material comprising a transition metal, wherein the transition metal is preferably one or more of Cu and Fe.
51. The process of embodiment 50, wherein the solution comprising ions of a transition metal according to (ix) is an aqueous solution comprising a dissolved salt of the transition metal M, preferably a dissolved inorganic salt of the transition metal M, more preferably a dissolved nitrate of the transition metal M.
52. The process of embodiment 50 or 51, wherein the solution comprising ions of a transition metal according to (ix) has a concentration of the transition metal in the range of from 0.0005 to 1 mol/l, preferably in the range of from 0.001 to 0.5 mol/l, more preferably in the range of from 0.002 to 0.2 mol/l.
53. The process of any one of embodiments 50 to 52, wherein according to (ix), the solution comprising ions of a transition metal M is brought in contact with the zeolitic material at a temperature of the solution in the range of from 10 to 40° C., preferably in the range of from 15 to 35° C., more preferably in the range of from 20 to 30° C.
54. The process of embodiment 53, wherein the solution comprising ions of a transition metal is brought in contact with the zeolitic material for a period of time in the range of from 6 to 48 h, preferably from 12 to 36 h, more preferably in the range of from 18 to 30 h.
55. The process of any one of embodiments 50 to 54, wherein bringing the solution in contact with the zeolitic material according to (ix) is repeated at least once.
56. The process of any one of embodiments 50 to 55, wherein bringing the solution in contact with the zeolitic material according to (ix) comprises one or more of impregnating the zeolitic material with the solution and spraying the solution onto the zeolitic material, preferably impregnating the zeolitic material with the solution.
57. The process of any one of embodiments 50 to 56, further comprising
   (x) separating the zeolitic material from the mixture obtained from (ix).
58. The process of embodiment 57, wherein separating the zeolitic material according to (x) comprises
   (x.1) subjecting the mixture obtained from (ix) to a solid-liquid separation method, preferably comprising a filtration method or a centrifugation method or a spraying method, obtaining the zeolitic material comprising a transition metal M;
   (x.2) preferably washing the zeolitic material obtained from (x.1);
   (x.3) drying the zeolitic material obtained from (x.1) or (x.2), preferably from (x.2).
59. The process of embodiment 58, wherein according to (x.2), the zeolitic material is washed with water, preferably until the washing water has a conductivity of at most 500 microSiemens, more preferably at most 200 microSiemens.
60. The process of embodiment 58 or 59, wherein according to (x.3), the zeolitic material is dried in a gas atmosphere having a temperature in the range of from 50 to 150° C., preferably in the range of from 75 to 125° C., more preferably in the range of from 90 to 110° C.
61. The process of embodiment 60, wherein the gas atmosphere comprises oxygen, preferably is air, lean air, or synthetic air.
62. The process of any one of embodiments 57 to 61, further comprising
   (xi) calcining the zeolitic material obtained from (x).
63. The process of embodiment 62, wherein according to (xi), the zeolitic material is calcined in a gas atmosphere having a temperature in the range of from 400 to 600° C., preferably in the range of from 450 to 550° C., more preferably in the range of from 475 to 525° C.
64. The process of embodiment 63, wherein the gas atmosphere comprises oxygen, preferably is one or more of oxygen, air, or lean air.
65. A zeolitic material comprising Ti, having framework type CHA and having a framework structure which comprises Si and O, obtainable or obtained by a process according to any one of embodiments 1 to 64.
66. The zeolitic material of embodiment 65, obtainable or obtained by a process according to any one of embodiments 1 to 39.
67. The zeolitic material of embodiment 65, obtainable or obtained by a process according to any one of embodiments 40 to 46.
68. The zeolitic material of embodiment 65, obtainable or obtained by a process according to any one of embodiments 47 to 49.
69. The zeolitic material of embodiment 65, obtainable or obtained by a process according to any one of embodiments 50 to 64.
70. A zeolitic material comprising Ti, preferably the zeolitic material according to embodiment 66, having framework type CHA and having a framework structure which comprises Si and O, preferably the zeolitic material according to embodiment 65, wherein from 95 to 100 weight-%, preferably from 98 to 100 weight weight-%, more preferably from 99 to 100 weight-% of the framework structure consist of Si, O, optionally Ti, and optionally H.
71. The zeolitic material of embodiment 70, wherein from 95 to 100 weight-%, preferably from 98 to 100 weight weight-%, more preferably from 99 to 100 weight-% of the framework structure consist of Si, O, Ti, and optionally H.
72. The zeolitic material of embodiment 70 or 71, wherein from 0 to 500 weight-ppm, preferably from 0 to 200 weight-ppm, more preferably from 0 to 100 weight-% of the framework structure consist of Al and/or wherein from 0 to 500 weight-ppm, preferably from 0 to 200 weight-ppm, more preferably from 0 to 100 weight-% of the framework structure consist of B.
73. The zeolitic material of any one of embodiments 70 to 72, wherein in the zeolitic material, the molar ratio of titanium relative to silicon, calculated as TiO₂:SiO₂, is in the range of from 0.005:1 to 0.1:1, preferably in the range of from 0.01:1 to 0.075:1, more preferably in the range of from 0.015:1 to 0.05:1, more preferably in the range of from 0.02:1 to 0.04:1.
74. The zeolitic material of any one of embodiments 70 to 73, wherein at least 75%, preferably at least 90%, more preferably at least 95% of the crystals of the zeolitic material consist of rhombohedra whose longest side is in the range of from 1 to 20 micrometer, preferably in the range of from 2 to 17 micrometer, more preferably in the range of from 3 to 15 micrometer, determined according to SEM as described in Reference Example 1.2.
75. The zeolitic material of any one of embodiments 70 to 74, exhibiting an FT-IR spectrum determined as described in Reference Example 1.3, having a peak with a minimum at (1040±10) cm⁻¹.
76. The zeolitic material of embodiment 75, exhibiting an FT-IR spectrum determined as described in Reference Example 1.3, having three further peaks with minima at (800±10) cm⁻¹, (645±10) cm⁻¹, and (550±10) cm⁻¹.
77. The zeolitic material of any one of embodiments 70 to 76, exhibiting a DTA spectrum determined as described in Reference Example 1.4, having a peak with a maximum at (444±2) cm⁻¹.
78. Use of the zeolitic material according to any one of embodiments 65 to 77 as a catalytically active material, as a catalyst, or as a catalyst component.
79. The use of embodiment 78 for the selective catalytic reduction of nitrogen oxides in an exhaust gas stream, preferably an exhaust gas stream from a diesel engine.
80. The use of embodiment 78 for the conversion of a C1 compound to one or more olefins, preferably for the conversion of methanol to one or more olefins or the conversion of a synthetic gas comprising carbon monoxide and hydrogen to one or more olefins, preferably for the conversion of methanol to one or more olefins or the conversion of a synthetic gas comprising carbon monoxide and hydrogen to one or more olefins.
81. The use of embodiment 78 for the oxidation of an alkene, preferably for the epoxidation of an alkene, wherein the alkene is preferably one or more of ethene and propene, more preferably is ethene.
82. A method for selectively catalytically reducing nitrogen oxides in an exhaust gas stream, preferably an exhaust gas stream from a diesel engine, said method comprising bringing said exhaust gas stream in contact with a catalyst comprising the zeolitic material according to any one of embodiments 65 to 77.
83. A method for selectively catalytically reducing nitrogen oxides in an exhaust gas stream, preferably an exhaust gas stream from a diesel engine, said method comprising preparing a zeolitic material by a process according to any one of embodiments 1 to 64, and bringing said exhaust gas stream in contact with a catalyst comprising said zeolitic material.
84. A method for catalytically converting a C1 compound to one or more olefins, preferably converting methanol to one or more olefins or converting a synthetic gas comprising carbon monoxide and hydrogen to one or more olefins, said method comprising bringing said C1 compound in contact with a catalyst comprising the zeolitic material according to any one of embodiments 65 to 77.
85. A method for catalytically converting a C1 compound to one or more olefins, preferably converting methanol to one or more olefins or converting a synthetic gas comprising carbon monoxide and hydrogen to one or more olefins, said method comprising preparing a zeolitic material by a process according to any one of embodiments 1 to 64, and bringing said C1 compound in contact with a catalyst comprising said zeolitic material,
86. A method for oxidation of an alkene, preferably for the epoxidation of an alkene, wherein the alkene is preferably one or more of ethene and propene, more preferably is ethene, said method comprising bringing said alkene in contact with a catalyst comprising the zeolitic material according to any one of embodiments 65 to 77.
87. A method for oxidation of an alkene, preferably for the epoxidation of an alkene, wherein the alkene is preferably one or more of ethene and propene, more preferably is ethene, said method comprising preparing a zeolitic material by a process according to any one of embodiments 1 to 64, and bringing said alkene in contact with a catalyst comprising said zeolitic material.
88. A catalyst, preferably a catalyst for selectively catalytically reducing nitrogen oxides in an exhaust gas stream, preferably an exhaust gas stream from a diesel engine, or for catalytically converting a C1 compound to one or more olefins, preferably converting methanol to one or more olefins, or for converting a synthetic gas comprising carbon monoxide and hydrogen to one or more olefins, or for the epoxidation of an alkene, said catalyst comprising the zeolitic material according to any one of embodiments 65 to 77.

The present invention is further illustrated by the following examples, comparative examples, and reference examples.

### EXAMPLES

### Reference Example 1.1: Determination of the XRD Patterns

The XRD diffraction patterns were determined using a Siemens D5000 powder diffractometer using Cu Kalpha1 radiation (lambda=1.54059 Å). Borosilicate glass capillaries (diameter: 0.3 mm) were used as a sample holder. The diffractometer was equipped with a germanium (111) primary monochromator and a Braun linear position-sensitive detector (2Theta coverage=6°).

### Reference Example 1.2: Scanning Electron Microscopy

The SEM (Scanning Electron Microscopy) pictures (secondary electron (SE) picture at 15 kV (kiloVolt)) were made using a LEO-1530 Gemini electron microscope at 20 kV to study the morphology of the crystals and the homogeneity of the samples. The samples were gold coated by vacuum vapour deposition prior to analysis.

### Reference Example 1.3: (ATR) FTIR Spectrum

The (ATR) FTIR Spectra were collected using a Nicolet 6700 FT-IR spectrometer. ATR-FTIR spectra between 400 and 4000 cm⁻¹ with a resolution of 4 cm⁻¹ using a Smart Orbit Diamond ATR unit.

### Reference Example 1.4: Thermoanalysis DTA and TG

The thermoanalysis DTA and TG were collected by simultaneous DTA/TG measurements using a Bahr STA-503 thermal analyser. The sample was heated in synthetic air from 30 to 1000° C. with a heating rate of 10 K/min.

### Reference Example 2: Titanium Silicalite-1

A TS-1 zeolitic material was prepared according to WO 2011/064191 A1, page 34, lines 19-39. The TS-1 zeolitic material was obtained wherein the framework structure had the following composition: (1-x) SiO₂.xTiO₂, with x=0.03. The TS-1 exhibited the following physical parameters:

The (ATR) FTIR spectrum shows signals assigned to the silicate framework at 434.6 cm⁻¹ (very strong), 545.7 cm⁻¹ (strong), 624.6 cm⁻¹ (very weak), 798.8 cm⁻¹ (medium), 958.6 cm⁻¹ (medium), 1068.3 cm⁻¹ (very strong) and 1220.6 cm⁻¹ (very weak). In addition there are two very weak signals at 1627 cm⁻¹ and centered at 3317 cm⁻¹ indicating the presence of a very small amount of water. According to the FTIR spectrum the material is free of organic matter. The ²⁹Si CP MAS NMR spectrum shows two signals at −102.7 ppm (Q3-type) and −112.6 ppm (Q4-type) with approx. relative intensities of 1.5 to 1. The ²⁹Si hpdec MAS NMR spectrum shows only one signal at −113.2 ppm (Q4-type).

### Examples 1 to 9: Protocol for the Inventive Examples

### Materials Used:

| | | |
|---|---|---|
| N,N,N-trimethyl-1-adamantylammonium | 2.89 | mL |
| hydroxide solution (AdaTMAOH) (1.04 molar): | | |
| Titanium silicalite-1 (TS-1) according to | 0.30 | g |
| Reference Example 2 | | |
| (optional) NaOH solution (1 molar) | 0.1 | mL |
| (optional) KOH solution (1 molar) | 0.1 | mL |
| (optional) Ti-CHA seeds | | |

2.89 mL of an aqueous AdaTMAOH solution (1.04 molar), 0.30 g TS-1, optionally 0.1 mL aqueous NaOH solution (1 molar) or optionally 0.1 mL aqueous KOH solution (1 molar), and optionally Ti-CHA seeds (1 weight-% of the total silicon content), were mixed in a Teflon beaker (volume of 45 mL) and stirred at room temperature for 10 min. The thus obtained pre-synthesis mixture had the following molar composition:

0.97 SiO₂:0.03 TiO₂:(optionally) 0.022 NaOH or KOH:0.66 AdaTMAOH:35 H₂O

The pre-synthesis mixture was then heated in a vacuum oven at a temperature T₁ and an absolute pressure of 50 mbar under static conditions for X₁ hours, and the loss of water was recorded. The thus obtained synthesis mixture had the molar composition:

0.97 SiO₂:0.03 TiO₂:(optionally) 0.022 NaOH or KOH:0.66 AdaTMAOH:Y₁H₂O

The hydrothermal crystallization step was then carried out as follows. The Teflon beaker containing the synthesis mixture was put into a steel autoclave, the autoclave was sealed, and then the autoclave was heated to 160° C. under static conditions for a number of days (d).

After pressure release and cooling to room temperature, the product (Ti-CHA which comprises Si and O in the framework) was thoroughly washed with distilled water, until the washing water had a conductivity of less than 200 microSiemens. The thus obtained washed product (Ti-CHA which comprises Si and O in the framework) was then separated by centrifugation and dried in air at room temperature overnight.

Based on the above protocol, a set of inventive examples 1 to 9 was carried out using the amounts and conditions as summarized in the following Table 1:

TABLE 1
Summary of the Inventive Examples

| | Inventive Examples | | | | | | | | |
|---|---|---|---|---|---|---|---|---|---|
| | 1 | 2 | 3 | 4 | 5 | 6 | 7 | 8 | 9 |
| SDA/mol | 0.66 | 0.66 | 0.66 | 0.66 | 0.66 | 0.66 | 0.66 | 0.66 | 0.66 |
| NaOH/mol | 0.022 | 0.022 | 0.022 | 0.066 | 0.011 | − | 0.022 | 0.022 | 0.022 |
| | | | KOH | | | | | | |
| Al(OH)₃/mol | − | − | − | − | − | − | − | − | − |
| (Ti-CHA) seeds | + | − | + | + | + | + | + | − | + |
| Ti/° C./X₁/h | 50/3 | 50/3 | 50/3 | 50/3 | 50/3 | 50/3 | 50/3 | 60/1.5 | 70/2 |
| Loss of H₂O/g | n.d. | 1.7 | 1.85 | n.d. | 1.25 | 1.90 | n.d. | 1.62 | 2.01 |
| Crystallization | 7 | 7 | 7 | 7 | 7 | 7 | 14 | 7 | 7 |
| time/d | | | | | | | | | |
| Pre-synthesis | 35:0.97 | 35:0.97 | 35:0.97 | 35:0.97 | 35:0.97 | 35:0.97 | 35:0.97 | 35:0.97 | 35:0.97 |
| mixture, molar | | | | | | | | | |
| ratio H₂O:SiO₂ | | | | | | | | | |
| synthesis | 20:0.97 | 16:0.97 | 14:0.97 | 20:0.97 | 21:0.97 | 13.5:0.97 | 20:0.97 | 17:0.97 | 12:0.97 |
| mixture, molar | | | | | | | | | |
| ratio H₂O:SiO₂ | | | | | | | | | |

### Notes for Table 1:

for Example 3, instead of NaOH, KOH was used.
for Examples 4 and 5 to obtain 0.066 mol and 0.011 mol of NaOH respectively, rather than 0.1 mL of NaOH solution (1 molar), 0.3 mL and 0.05 mL was employed respectively.
− indicates that the respective component was not employed.
+ indicates that Ti-CHA seeds were employed.
n.d. indicates “not determined”
For each of the inventive examples a Ti-CHA product was obtained as confirmed by XRD in accordance with reference example 1.1.

As can readily be seen from Table 1, the product Ti-CHA which comprises Si and O was obtained with each of examples 1 to 9. Notably, Examples 1 and 2 for instance highlight that a Ti-CHA seed although not essential, may optionally be employed. Example 6 demonstrates that a source of an alkali metal is not essential, although varying amounts of an alkali metal may optionally be employed as demonstrated by examples 3 to 5. Furthermore, example 7 highlights that optionally longer hydrothermal crystallization times may be employed. Finally, examples 8 and 9 demonstrate some further conditions for removing water from the pre-synthesis mixture. Analytical data for Ti-CHA obtained according to the invention are provided in FIGS. 1 to 4.

### Comparative Examples 1 to 5: Protocol for the Comparative Examples

For comparative examples 1 to 5, a similar protocol was employed based on that used for the inventive examples, with the following modifications as summarized in Table 2:

TABLE 2
Summary of the Comparative Examples

| Comparative | | | | | |
|---|---|---|---|---|---|
| Examples | 1 | 2 | 3 | 4 | 5 |
| SDA/mol | 0.66 | 0.66 | 0.36 | 0.36 | 0.66 |
| NaOH/mol | 0.022 | 0.22 | 0.017 | 0.017 | 0.022 |
| Al(OH)₃/mol | − | − | − | − | 0.9 |
| (Ti-CHA) seeds | + | − | − | − | − |
| T₁/° C./X₁/h | none | none | “boiled” | 50/3 | 50/3 |
| Loss of H₂O/g | none | none | n.d. | n.d. | n.d. |
| Crystallization | 7 | 7 | 7 | 6 | 7 |
| time (d) | | | | | |
| Product | amorphous | mainly | mixture of | mixture of | mainly |
| obtained | material | amorphous | TS-1 and | TS-1 and | amorphous |
| | | material | amorphous | amorphous | material |
| | | | material | material | |
| Pre-synthesis | 35:0.97 | 35:0.97 | 35:0.97 | 35:0.97 | 35:0.97 |
| mixture, molar | | | | | |
| ratio H₂O:SiO₂ | | | | | |
| Synthesis | 35:0.97 | 35:0.97 | 30:0.97 | 20:0.97 | 20:0.97 |
| reaction | | | | | |
| mixture, molar | | | | | |
| ratio H₂O:SiO₂ | | | | | |

### Notes for Table 2:

for comparative examples 1 and 12 “none” indicates the protocol did not include heating in a vacuum oven at T₁ and ca. 50 mbar; hence there was no removal of water from the pre-synthesis mixture.
for comparative example 2, 1 mL of NaOH (1 molar) was employed when preparing the pre-synthesis mixture.
for comparative examples 3 and 4 0.075 mL of NaOH solution (1 molar) and 1.5 mL of (AdaTMAOH) (1.04 molar) was employed to obtain 0.017 and 0.36 mol respectively when preparing the pre-synthesis mixture.
− indicates that the respective component was not employed.
+ indicates that that Ti-CHA seeds were employed.
n.d. indicates “not determined”.
The product obtained was determined by XRD according to reference example 1.1.
for comparative example 5, 0.3 g Al(OH)₃ were added when preparing the pre-synthesis mixture.

As can readily be seen from Table 2, Comparative Examples 1 to 3, if the step of removing water from the pre-synthesis mixture is omitted, mixtures comprising significant amounts of amorphous material rather than Ti-CHA are obtained. Furthermore, Comparative Example 4 highlights that if a molar ratio of AdaTMAOH (SDA):SiO₂ of at least 0.4:1 is not employed, a mixture comprising mainly amorphous material is obtained. Finally, Comparative Example 5 highlights that when aluminium is comprised in the pre-synthesis mixture, this has a detrimental effect, whereby a mixture comprising mainly amorphous material was obtained.

### BRIEF DESCRIPTION OF THE FIGURES

FIG. 1: shows the XRD pattern of Ti-CHA according to the invention.

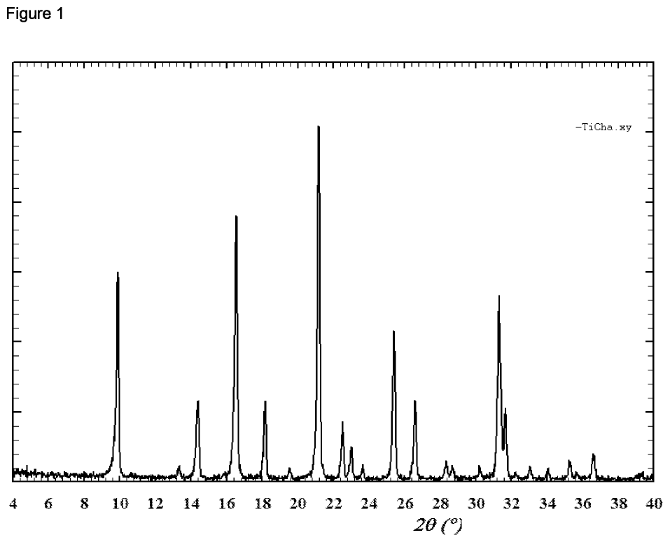

FIG. 2: shows the SEM picture of Ti-CHA according to the invention. As can be seen, Ti-CHA crystallizes as small rhombohedra having edges with a length of about 3-15 micrometer.

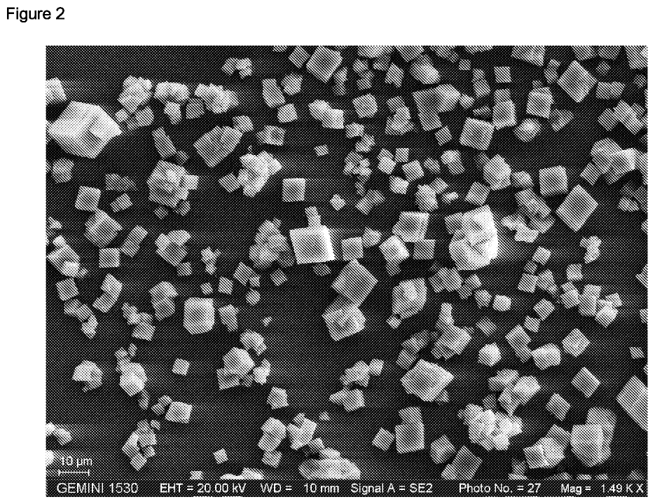

FIG. 3: shows the (ATR) FTIR Spectrum of Ti-CHA according to the invention. The x-axis shows the wave number/cm⁻¹

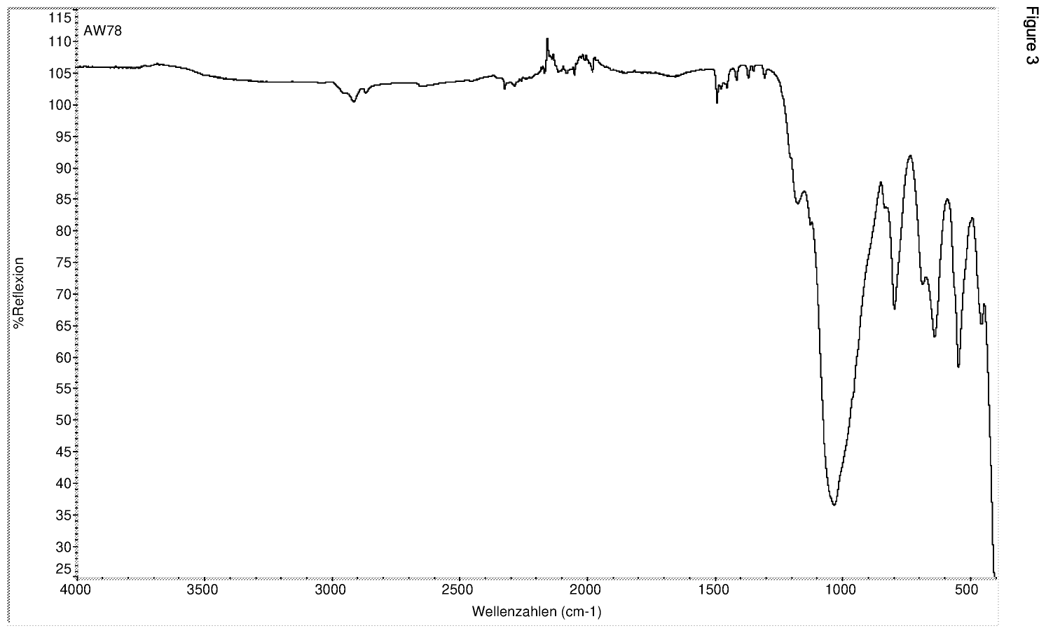

FIG. 4: shows the thermoanalysis DTA and TG of Ti-CHA according to the invention.

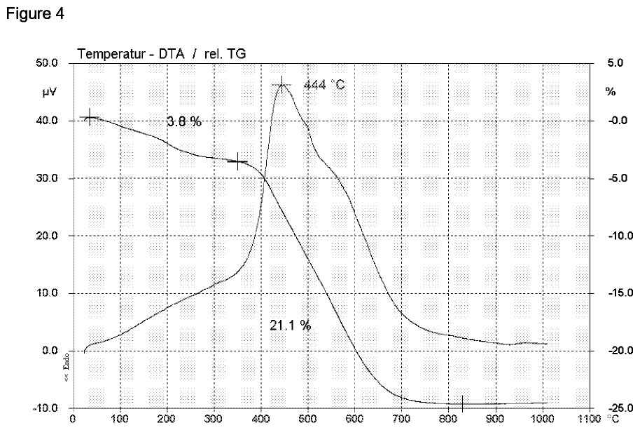

### CITED PRIOR ART

WO 2011/06419 A1

1. A process for preparing a zeolitic material comprising Ti, having framework type CHA and having a framework structure which comprises Si and O, said process comprising:
(i) preparing a pre-synthesis mixture comprising water, a CHA framework structure directing agent, and a zeolitic material comprising Ti, having framework type MFI and having a framework structure which comprises Si and O, wherein a molar ratio of the CHA framework structure directing agent relative to Si, comprised in the zeolitic material having framework type MFI and calculated as SiO₂, said molar ratio being defined as SDA:SiO₂, is at least 0.4:1, and wherein a molar ratio of water relative to Si, comprised in the zeolitic material having framework type MFI and calculated as SiO₂, said molar ratio being defined as H₂O:SiO₂, is at least 30:1;
(ii) removing water from the pre-synthesis mixture by heating the pre-synthesis mixture to a temperature of less than 100° C. at a pressure of less than 1 bar(abs) and keeping the temperature of the pre-synthesis mixture in this range and the pressure of the pre-synthesis mixture in this range, obtaining a synthesis mixture comprising water, the CHA framework structure directing agent, and the zeolitic material having framework type MFI, wherein a molar ratio of water relative to Si, comprised in the zeolitic material having framework type MFI and calculated as SiO₂, said molar ratio being defined as H₂O:SiO₂, is at most 25:1;
(iii) hydrothermally crystallizing the zeolitic material comprising Ti, having framework type CHA and having a framework structure which comprises Si and O, comprising heating the synthesis mixture to a temperature in the range of from 140 to 200° C. and keeping the temperature of the synthesis mixture in this range under autogenous pressure, obtaining a mother liquor comprising water and the zeolitic material comprising Ti, having framework type CHA and having a framework structure which comprises Si and O.

2. The process of claim 1, wherein the CHA framework structure directing agent comprises one or more of a N-alkyl-3-quinuclidinol, a N,N,N-trialkylexoaminonorbornane, a N,N,N-trimethyl-1-adamantylammonium compound, a N,N,N-trimethyl-2-adamantyl-ammonium compound, a N,N,N-trimethylcyclohexylammonium compound, a N,N-dimethyl-3,3-dimethylpiperidinium compound, a N,N-methylethyl-3,3-dimethylpiperidinium compound, a N,N-dimethyl-2-methylpiperidinium compound, 1,3,3,6,6-pentamethyl-6-azonio-bicyclo(3.2.1)octane, N,N-dimethylcyclohexylamine, and a N,N,N-trimethylbenzyl-ammonium compound.

3. The process of claim 1, wherein at least 99 weight %, of the zeolitic material having framework type MFI consist of Si, Ti, O, and H.

4. The process of claim 1, wherein in the pre-synthesis mixture, a molar ratio SDA:SiO₂ is in the range of from 0.4:1 to 2:1, and
wherein in the pre-synthesis mixture, a molar ratio H₂O:SiO₂, is in the range of from 30:1 to 50:1.

5. The process of claim 1,
wherein the pre-synthesis mixture further comprises a crystalline seed material comprising a zeolitic material comprising Ti, having framework type CHA and having a framework structure which comprises Si and O, and
wherein in the pre-synthesis mixture, a molar ratio of Si, comprised in the zeolitic material having framework type CHA comprised in the seed material and calculated as elemental Si, relative to Si, comprised in the zeolitic material having framework type MFI and calculated as SiO₂.

6. The process of claim 1, wherein at least 95 weight % of the pre-synthesis mixture consist of water, the CHA framework structure directing agent, the zeolitic material comprising Ti, having framework type MFI and having a framework structure comprising Si and O.

7. The process of claim 1, wherein in the synthesis mixture, the molar ratio of water relative to relative to Si, comprised in the zeolitic material having framework type MFI and calculated as SiO₂, said molar ratio being defined as H₂O:SiO₂, is in the range of from 5:1 to 25:1.

8. The process of claim 1, wherein the hydrothermally crystallizing according to (iii) comprises heating the synthesis mixture to a temperature in the range of from 145 to 190° C.

9. The process of claim 1, further comprising
(iv) cooling the mother liquor;
(v) separating the zeolitic material from the mother liquor.

10. A zeolitic material, obtained by the process according to claim 1, comprising Ti, having framework type CHA and having a framework structure which comprises Si and O, wherein from 95 to 100 weight % of the framework structure consist of Si, O, optionally Ti, and optionally H.

11. The zeolitic material of claim 10, wherein from 95 to 100 weight % of the framework structure consist of Si, O, Ti, and optionally H.

12. The zeolitic material of claim 10, wherein at least 75%, of the crystals of the zeolitic material consist of rhombohedra whose longest edge is in the range of from 1 to 20 micrometer, determined according to SEM.

13. The zeolitic material of claim 10, exhibiting an FT-IR spectrum determined having a peak with a minimum at (1040±10) cm⁻¹.

14. The zeolitic material of claim 10, exhibiting a DTA spectrum determined having a peak with a maximum at (444±2) cm⁻¹.

15. An article, comprising:
the zeolitic material according to claim 10
wherein the article is a catalytically active material, a catalyst, or a catalyst component.

16. A catalyst, comprising the zeolitic material according to claim 10.
